(19) United States
(12) Patent Application Publication
(10) Pub. No.: US 2023/0301366 A1
(43) Pub. Date: Sep. 28, 2023

(54) E-CIGARETTE AND CONTROL METHOD THEREOF

(71) Applicant: SHENZHEN FIRST UNION TECHNOLOGY CO., LTD., Shenzhen City, Guangdong Province (CN)

(72) Inventors: JUNJIE LI, Shenzhen City, Guangdong Province (CN); CIRONG GUO, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/022,135

(22) PCT Filed: Aug. 16, 2021
(86) PCT No.: PCT/CN2021/112818

§ 371 Date: Feb. 17, 2023

(30) Foreign Application Priority Data
Aug. 17, 2020 (CN) 202010825884.X

(51) Int. Cl. A24F 40/57; A24F 40/10; A24F 40/42; A24F 40/46; A24F 40/30

(52) U.S. Cl. CPC A24F 40/57; A24F 40/10; A24F 40/42; A24F 40/46; A24F 40/30; A24F 40/51

(57) ABSTRACT

An e-cigarette includes at least one liquid storage unit, configured to store a liquid that can generate an aerosol; a first heating assembly and a second heating assembly, both configured to receive the liquid from the liquid storage unit and heat the liquid to generate the aerosol for a user to inhale; and a circuit, electrically connected to the first heating assembly and the second heating assembly. The circuit is configured for adopting a control method to control the first heating assembly and the second heating assembly to alternately start heating according to an inhalation feature parameter of the e-cigarette during vaping of the e-cigarette. The first heating assembly and the second heating assembly are controlled to alternately start heating, so as to avoid the problem of burnt core due to delayed or insufficient supply of the e-liquid during vaping of a user, thereby improving vaping experience of the user.

### CROSS-REFERENCE TO RELATED APPLICATIONS

This application claims priority to Chinese Patent Application No. 202010825884.X, entitled “E-CIGARETTE AND CONTROL METHOD THEREOF” and filed with the China National Intellectual Property Administration on Aug. 17, 2020, which is incorporated herein by reference in its entirety.

### TECHNICAL FIELD

This application relates to the technical field of cigarette devices, and in particular, to an e-cigarette and a control method thereof.

### BACKGROUND

An e-cigarette is an electronic product that generates vapor by heating an e-liquid for a user to inhale. The e-cigarette generally has two parts: a vaporizer and a battery assembly. The vaporizer stores the e-liquid inside and is provided with a vaporization core for heating the e-liquid. The battery assembly can supply power to the vaporization core so that the vaporization core generates heat to reach a high temperature to heat the e-liquid.

The existing e-cigarette has a problem of delayed or insufficient supply of the e-liquid during vaporization of the e-liquid, which results in a burnt core and hurts the vaping experience of the user.

### SUMMARY

This application provides an e-cigarette and a control method thereof, to resolve a problem in an existing e-cigarette that the supply of an e-liquid is not timely or sufficient.

According to an aspect of this application, a control method of an e-cigarette is provided, where the e-cigarette includes:
at least one liquid storage unit, configured to store a liquid that generates an aerosol;
a first heating assembly and a second heating assembly, both configured to receive the liquid from the liquid storage unit and heat the liquid to generate the aerosol for a user to inhale; and
a circuit, electrically connected to the first heating assembly and the second heating assembly,
the control method includes:
controlling the first heating assembly and the second heating assembly to alternately start heating according to an inhalation feature parameter of the e-cigarette during vaping of the e-cigarette.

According to another aspect of this application, an e-cigarette is provided, including:
at least one liquid storage unit, configured to store a liquid that generates an aerosol;
a first heating assembly and a second heating assembly, both configured to receive the liquid from the liquid storage unit and heat the liquid to generate the aerosol for a user to inhale; and
a circuit, electrically connected to the first heating assembly and the second heating assembly,
where the circuit is configured to control the first heating assembly and the second heating assembly to alternately start heating according to an inhalation feature parameter of the e-cigarette during vaping of the e-cigarette.

In the e-cigarette and the control method thereof provided in this application, the first heating assembly and the second heating assembly are controlled to alternately start heating, so as to avoid a core is burnt due to delayed or insufficient supply of the e-liquid when a user vapes, thereby improving the vaping experience of the user.

### BRIEF DESCRIPTION OF THE DRAWINGS

The objective implementation, functional features and advantages of this application are further illustrated with reference to the accompanying drawings by using the embodiments. One or more embodiments are exemplarily described with reference to the corresponding figures in the accompanying drawings, and the descriptions are not to be construed as limiting the embodiments. Components in the accompanying drawings that have same reference numerals are represented as similar components, and unless otherwise particularly stated, the figures in the accompanying drawings are not drawn to scale.

FIG. 1 is a schematic diagram of an e-cigarette according to an embodiment of this application;

FIG. 2 is a schematic diagram of another e-cigarette according to an embodiment of this application;

FIG. 3 is a schematic flowchart of a control method of an e-cigarette according to an embodiment of this application;

FIG. 4 is a schematic flowchart of determining to start another heating assembly alternately in a control method of an e-cigarette according to an embodiment of this application; and

FIG. 5 is a schematic diagram of a control process of an e-cigarette according to an embodiment of this application.

### DETAILED DESCRIPTION

It is to be understood that the specific embodiments described herein are only used for explaining this application, and are not used for limiting this application. For ease of understanding of this application, this application is described below in more detail with reference to the accompanying drawings and specific implementations. It is to be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outside”, and similar expressions used in this specification are merely used for an illustrative purpose.

Unless otherwise defined, meanings of all technical and scientific terms used in this specification are the same as that usually understood by a person skilled in the technical field to which this application belongs. The terms used in the specification of this application are merely intended to describe objectives of the specific implementations, and are not intended to limit this application. The term “and/or” used in this specification includes any or all combinations of one or more related listed items.

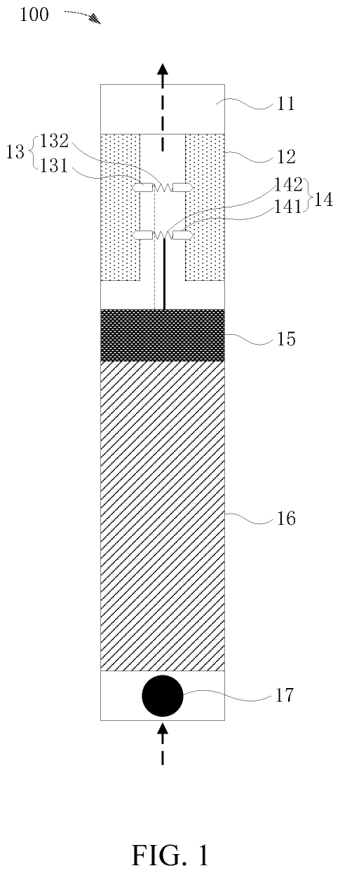

FIG. 1 is a schematic diagram of an e-cigarette according to an embodiment of this application.

As shown in FIG. 1, an e-cigarette 100 includes a suction nozzle 11, a liquid storage unit 12, a first heating assembly 13, a second heating assembly 14, a circuit 15, a battery 16, and a sensor 17.

The suction nozzle 11 is configured to allow a user to inhale an aerosol generated by heating.

The liquid storage unit 12 is configured to store a liquid that can generate an aerosol. The liquid may be a liquid that includes a tobacco-containing substance having a volatile tobacco-flavor component, and may also be a liquid that includes a non-tobacco substance. For example, the liquid may include water, a solvent, ethanol, a plant extract, a fragrance, a flavoring agent, or a vitamin mixture. The fragrance may include, but is not limited to, menthol, peppermint, spearmint oil, various fruit-flavor components, and the like. The flavoring agent may include components that can provide various fragrances or flavors for the user. The vitamin mixture may be, but is not limited to, a mixture of at least one of vitamin A, vitamin B, vitamin C, and vitamin E. In addition, the liquid may include aerosol-forming agents, such as glycerol and propylene glycol.

The first heating assembly 13 and the second heating assembly 14 are both configured to receive the liquid from the liquid storage unit 12 and heat the liquid to generate an aerosol for the user to inhale.

Specifically, the first heating assembly 13 includes a first liquid transfer unit 131 and a first heating element 132, and the second heating assembly 14 includes a second liquid transfer unit 141 and a second heating element 142.

The liquid transfer unit can transfer the liquid stored in the liquid storage unit 12 to the heating element. For example, the liquid transfer unit may be, but is not limited to, cotton fiber, ceramic fiber, glass fiber, or the like.

The heating element is configured to heat the liquid transferred by the liquid transfer unit. For example, the heating element may be, but is not limited to, a metal wire, a metal plate, a ceramic heater, or the like. Besides, the heating element may be made of conductive heating wires, for example, nickel-chromium wires, and may be arranged as a structure wound around the liquid transfer unit. The heating element may be heated through a current supply and transfers heat to a liquid in contact with the heating element so as to heat the liquid to generate an aerosol.

In this embodiment, the first liquid transfer unit 131 transfers the liquid in the liquid storage unit 12 to the first heating element 132, and the first heating element 132 is configured to heat the liquid transferred by the first liquid transfer unit 131. The second liquid transfer unit 141 transfers the liquid in the liquid storage unit 12 to the second heating element 142, and the second heating element 142 is configured to heat the liquid transferred by the second liquid transfer unit 141.

The circuit 15 can control overall operations of the e-cigarette 100. Specifically, the circuit 15 not only controls operations of the battery 16 and the heating assemblies, but also controls operations of other elements in the e-cigarette 100. Moreover, the circuit 15 may determine whether the e-cigarette 100 is operable by checking states of components of the e-cigarette 100.

The circuit 15 includes at least one processor. The processor may include a logic gate array, or may include a combination of a general-purpose microprocessor and a memory that stores a program executable on the microprocessor. In addition, a person skilled in the art may understand that the circuit 15 may include hardware of another type.

In this embodiment, the circuit 15 is electrically connected to the first heating element 132 and the second heating element 142. The circuit 15 is configured to control the first heating element 132 and the second heating element 142 to alternately start heating according to an inhalation feature parameter of the e-cigarette 100 during vaping of the e-cigarette 100.

In other words, during vaping of the e-cigarette 100, only one of the first heating element 132 and the second heating element 142 starts heating. The first heating element 132 and the second heating element 142 alternately start heating according to the inhalation feature parameter of the e-cigarette 100. In this way, when one of the heating elements starts heating, there is enough time for the liquid transfer unit corresponding to the other heating element to transfer the liquid in the liquid storage unit 12 to the other heating element, thereby avoiding the problem of burnt core due to delayed or insufficient supply of the e-liquid in the related art.

In this embodiment, the inhalation feature parameter is selected from at least one of the following:
inhalation times, an inhalation duration, an inhalation volume, an inhalation frequency, a resistance value of a heating assembly, a resistance value change of a heating assembly, a temperature of a heating assembly, and a temperature change of a heating assembly.

The battery 16 supplies power for operating the e-cigarette 100. For example, the battery 16 may supply power to heat the heating assemblies, and may supply power for operating the circuit 15. Besides, the battery 16 may supply power for operating the sensor, a motor, and the like provided in the e-cigarette 100.

The battery 16 may be, but is not limited to, a lithium iron phosphate (LiFePO4) battery. For example, the battery 16 may be a lithium cobaltate (LiCoO2) battery or a lithium titanate battery. The battery 16 may be a rechargeable battery or a disposable battery. In this embodiment, the battery 16 is a disposable battery.

The sensor 17 is configured to detect an inhalation action of the user and generate a corresponding electrical signal, so that the circuit 15 controls operations of the battery 16 and the heating assemblies according to the electrical signal. The sensor 17 may be, but is not limited to, a common pressure sensor, such as a microphone.

The e-cigarette 100 is provided with an air inlet hole near the sensor 17. During vaping of the e-cigarette 100, airflow enters through the air inlet hole, passes through the sensor 17, the battery 16, the circuit 15, the heating assemblies, and the like, and exits through the suction nozzle 11. Dashed-line arrows in the figure roughly show the airflow path.

It is to be noted that, FIG. 1 only shows components relevant to this embodiment. A person of ordinary skill in the technical field should understand that the e-cigarette 100 further includes other all-purpose components in addition to the components shown in FIG. 1.

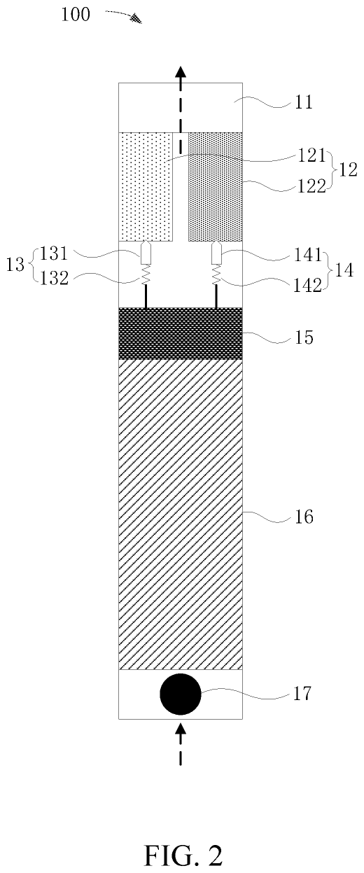

FIG. 2 is a schematic diagram of another e-cigarette 100 according to an embodiment of this application. Different from the e-cigarette shown in FIG. 1, a liquid storage unit 12 includes a first liquid storage unit 121 and a second liquid storage unit 122 that are separated from each other. The first liquid storage unit 121 is configured to store a first liquid, and the second liquid storage unit 122 is configured to store a second liquid. The first liquid transfer unit 131 transfers the first liquid in the first liquid storage unit 121 to the first heating element 132, and the first heating element 132 is configured to heat the first liquid transferred by the first liquid transfer unit 131. The second liquid transfer unit 141 transfers the second liquid in the second liquid storage unit 122 to the second heating element 142, and the second heating element 142 is configured to heat the second liquid transferred by the second liquid transfer unit 141.

Components of the first liquid may be the same as or different from components of the second liquid. In this embodiment, the components of the first liquid are different from the components of the second liquid. Therefore, during inhalation, the user may enjoy aerosols of different flavors when the first heating element 132 and the second heating element 142 alternately start heating, thereby further improving the vaping experience of the user.

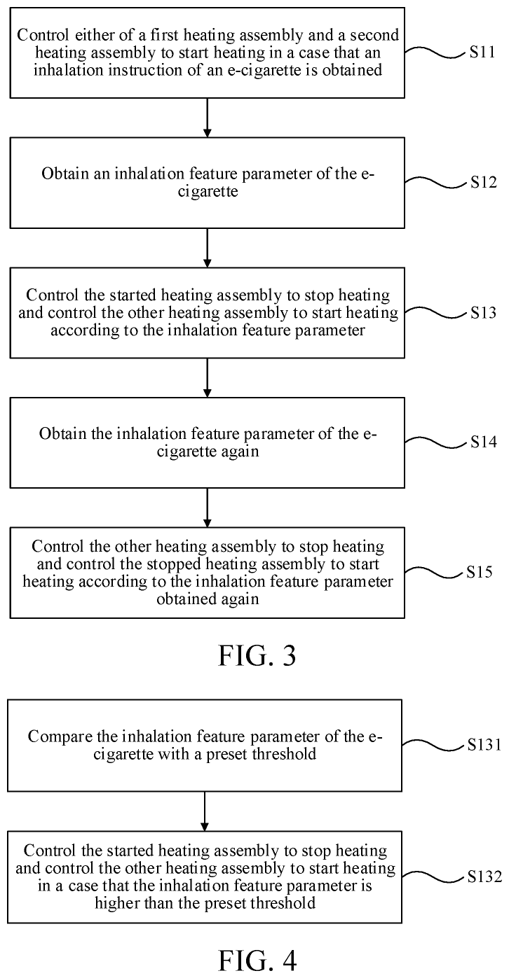

FIG. 3 is a schematic flowchart of a control method of an e-cigarette according to an embodiment of this application. As shown in FIG. 3, the method includes the following steps:

Step S11. Control either of the first heating assembly and the second heating assembly to start heating in a case that an inhalation instruction of the e-cigarette is obtained.

Specifically, during vaping of the e-cigarette 100, when airflow enters the sensor 17 through the air inlet hole, the sensor 17 may detect the inhalation action of the user and generate a corresponding electrical signal. For example, when the user vapes, an airway pressure in the e-cigarette 100 is lower than an external airflow pressure, the microphone outputs a high level signal. The circuit 15 may determine the occurrence of an inhalation action after obtaining the high level signal, and then control either of the first heating element 132 and the second heating element 142 to start heating to generate an inhalable aerosol for the user.

Step S12. Obtain an inhalation feature parameter of the e-cigarette.

In this embodiment, the inhalation feature parameter is selected from at least one of the following:
inhalation times, an inhalation duration, an inhalation volume, an inhalation frequency, a resistance value of a heating assembly, a resistance value change of a heating assembly, a temperature of a heating assembly, and a temperature change of a heating assembly.

For example, when the inhalation action of the user is detected through the microphone, the inhalation times of the user may be counted by using a counter or the inhalation duration of the user may be timed by a timer, where the inhalation duration may be a duration of one or more inhalation actions. Alternatively, the inhalation volume and the inhalation frequency may be obtained through calculation based on the inhalation times and the inhalation duration.

When the heating element is an element with a resistance-temperature characteristic, a resistance value of the heating element changes significantly with a change of a working temperature. Therefore, the resistance value of the heating element may be obtained through calculation by detecting a working current and voltage of the heating element. Alternatively, a sampling resistor may be connected in series with the heating element, and the resistance value of the heating element may be based on voltage distribution of the sampling resistor and the heating element and a total voltage. Generally, the resistance of the heating element is proportional to the temperature. Therefore, the temperature and temperature change of the heating element may be further determined.

Step S13. Control the started heating assembly to stop heating and control the other heating assembly to start heating according to the inhalation feature parameter.

Specifically, after the inhalation feature parameter of the e-cigarette 100 is obtained, according to the inhalation feature parameter, the started heating element may be controlled to stop heating and the other heating element may be controlled to start heating, thereby implementing a switch between the heating elements. Therefore, the problem of burnt core due to delayed or insufficient supply of the e-liquid to the started heating element is avoided. Meanwhile, there is enough time for the liquid transfer unit corresponding to the other heating element to transfer the liquid in the liquid storage unit 12 to the other heating element.

As shown in FIG. 4, step S13 specifically includes the following steps:

Step S131. Compare the inhalation feature parameter with a preset threshold.

Step S132. Control the started heating assembly to stop heating and control the other heating assembly to start heating in a case that the inhalation feature parameter is higher than the preset threshold.

Specifically, the inhalation times is compared with preset inhalation times, or the inhalation duration is compared with a preset inhalation duration, or a resistance value of the started heating element is compared with a preset resistance value, or a temperature of the started heating element is compared with a preset temperature; then, the started heating element is controlled to stop heating and the other heating element is controlled to start heating based on a comparison result, thereby implementing a switch between the heating elements.

Step S14. Obtain the inhalation feature parameter of the e-cigarette again.

Step S15. Control the other heating assembly to stop heating and control the stopped heating assembly to start heating according to the inhalation feature parameter obtained again.

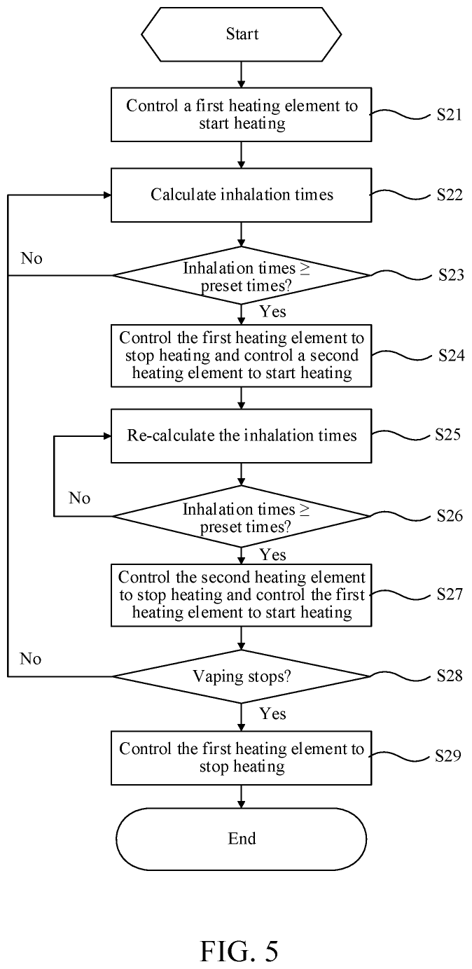

FIG. 5 is a schematic diagram of a control process of an e-cigarette according to an embodiment of this application. The control process is illustrated by using the inhalation times as an example, and specifically includes the following steps:

Step S21. Control the first heating element 132 to start heating in a case that an inhalation instruction of the e-cigarette is obtained.

Step S22. Detect an inhalation action of a user through the sensor 17 and calculate inhalation times.

Step S23. Control the first heating element 132 to stop heating and control the second heating element 142 to start heating (step S24) in a case that the calculated inhalation times is greater than or equal to preset inhalation times; otherwise, continue to detect the inhalation action of the user through the sensor 17 and calculate the inhalation times (step S22).

Step S25. Detect the inhalation action of the user through the sensor 17 and re-calculate inhalation times.

Step S26. Control the second heating element 142 to stop heating and control the first heating element 132 to start heating (step S27) in a case that the re-calculated inhalation times is greater than or equal to the preset inhalation times. otherwise, continue to detect the inhalation action of the user through the sensor 17 and calculate the inhalation times (step S25).

Step S28. Determine whether the user stops inhalation through the sensor 17, and control the first heating element 132 to stop heating (step S29) in a case that the user stops inhalation, and inhalation ends; otherwise, continue to detect the inhalation action of the user through the sensor 17 and calculate the inhalation times (step S22).

It is to be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or modifications according to the foregoing description, and all the improvements and modifications shall fall within the protection scope of the attached claims of this application.

1. A control method of an e-cigarette, wherein the e-cigarette comprises:
at least one liquid storage unit, configured to store a liquid that generates an aerosol;
a first heating assembly and a second heating assembly, both configured to receive the liquid from the liquid storage unit and heat the liquid to generate the aerosol for a user to inhale; and
a circuit, electrically connected to the first heating assembly and the second heating assembly;
wherein the control method comprises:
controlling the first heating assembly and the second heating assembly to alternately start heating according to an inhalation feature parameter of the e-cigarette during vaping of the e-cigarette.

2. The control method according to claim 1, wherein the control method further comprises:
controlling either of the first heating assembly and the second heating assembly to start heating in a case that an inhalation instruction of the e-cigarette is obtained.

3. The control method according to claim 2, wherein the control method further comprises:
obtaining the inhalation feature parameter in a case that either of the first heating assembly and the second heating assembly is controlled to start heating; and
controlling the either of the first heating assembly and the second heating assembly to stop heating and controlling the other of the first heating assembly and the second heating assembly to start heating according to the inhalation feature parameter.

4. The control method according to claim 3, wherein the controlling the either of the first heating assembly and the second heating assembly to stop heating and controlling the other of the first heating assembly and the second heating assembly to start heating according to the inhalation feature parameter comprises:
comparing the inhalation feature parameter with a preset threshold; and
controlling the either of the first heating assembly and the second heating assembly to stop heating and controlling the other of the first heating assembly and the second heating assembly to start heating in a case that the inhalation feature parameter is higher than the preset threshold.

5. The control method according to claim 3, wherein after the controlling the either of the first heating assembly and the second heating assembly to stop heating and controlling the other of the first heating assembly and the second heating assembly to start heating according to the inhalation feature parameter, the method further comprises:
obtaining the inhalation feature parameter again; and
controlling the other of the first heating assembly and the second heating assembly to stop heating and controlling the either of the first heating assembly and the second heating assembly to start heating according to the inhalation feature parameter obtained again.

6. The control method according to claim 1, wherein the inhalation feature parameter is selected from at least one of the following:
inhalation times, an inhalation duration, an inhalation volume, an inhalation frequency, a resistance value of a heating assembly, a resistance value change of a heating assembly, a temperature of a heating assembly, and a temperature change of a heating assembly.

7. An e-cigarette, comprising:
at least one liquid storage unit, configured to store a liquid that generates an aerosol;
a first heating assembly and a second heating assembly, both configured to receive the liquid from the liquid storage unit and heat the liquid to generate the aerosol for a user to inhale; and
a circuit, electrically connected to the first heating assembly and the second heating assembly;
wherein the circuit is configured to control the first heating assembly and the second heating assembly to alternately start heating according to an inhalation feature parameter of the e-cigarette during vaping of the e-cigarette.

8. The e-cigarette according to claim 7, wherein the liquid storage unit comprises a first liquid storage unit and a second liquid storage unit that are separated from each other;
the first liquid storage unit is configured to store a first liquid;
the first heating assembly is configured to receive the first liquid from the first liquid storage unit and heat the first liquid;
the second liquid storage unit is configured to store a second liquid; and
the second heating assembly is configured to receive the second liquid from the second liquid storage unit and heat the second liquid.

9. The e-cigarette according to claim 8, wherein components of the first liquid are different from components of the second liquid.

10. The e-cigarette according to claim 7, wherein the first heating assembly and the second heating assembly each comprise a liquid transfer unit and a heating element;
the liquid transfer unit is configured to transfer the liquid in the liquid storage unit to the heating element; and
the heating element is configured to heat the liquid transferred by the liquid transfer unit.

11. The control method according to claim 4, wherein after the controlling the either of the first heating assembly and the second heating assembly to stop heating and controlling the other of the first heating assembly and the second heating assembly to start heating according to the inhalation feature parameter, the method further comprises:
obtaining the inhalation feature parameter again; and
controlling the other of the first heating assembly and the second heating assembly to stop heating and controlling the either of the first heating assembly and the second heating assembly to start heating according to the inhalation feature parameter obtained again.

12. The control method according to claim 2, wherein the inhalation feature parameter is selected from at least one of the following:
inhalation times, an inhalation duration, an inhalation volume, an inhalation frequency, a resistance value of a heating assembly, a resistance value change of a heating assembly, a temperature of a heating assembly, and a temperature change of a heating assembly.

13. The control method according to claim 3, wherein the inhalation feature parameter is selected from at least one of the following:
inhalation times, an inhalation duration, an inhalation volume, an inhalation frequency, a resistance value of a heating assembly, a resistance value change of a heating assembly, a temperature of a heating assembly, and a temperature change of a heating assembly.

14. The control method according to claim 4, wherein the inhalation feature parameter is selected from at least one of the following:
inhalation times, an inhalation duration, an inhalation volume, an inhalation frequency, a resistance value of a heating assembly, a resistance value change of a heating assembly, a temperature of a heating assembly, and a temperature change of a heating assembly.

15. The control method according to claim 5, wherein the inhalation feature parameter is selected from at least one of the following:
inhalation times, an inhalation duration, an inhalation volume, an inhalation frequency, a resistance value of a heating assembly, a resistance value change of a heating assembly, a temperature of a heating assembly, and a temperature change of a heating assembly.
